(19) United States
(12) Patent Application Publication
(10) Pub. No.: US 2014/0175984 A1
(43) Pub. Date: Jun. 26, 2014

(54) LIGHTING DEVICE WITH A PROTECTION CIRCUIT HAVING DISABLE WINDING

(71) Applicant: GENERAL ELECTRIC COMPANY, Schenectady, NY (US)

(72) Inventors: James Dominic Mieskoski, Seven Hills, OH (US); Gang Yao, Mayfield Heights, OH (US)

(73) Assignee: GENERAL ELECTRIC COMPANY, Schenectady, NY (US)

(21) Appl. No.: 13/721,211

(22) Filed: Dec. 20, 2012

(51) Int. Cl. H05B 41/36

(52) U.S. Cl. CPC H05B 41/36
USPC 315/127

(57) ABSTRACT

This disclosure describes embodiments of a lighting device with circuitry that can manage current and voltage levels across a plurality of fluorescent lamps. In one embodiment, the circuitry has cross-coupled inductors in series with a pair of lamp sockets. This configuration of components causes fluorescent lamps installed in the lamp sockets to generate substantially the same amount of light by drawing approximately equivalent current throughout the entire operable range of a dimmer control. The circuitry also includes a protection circuit with a winding magnetically coupled with the cross-coupled inductors and a control circuit that can cause impedance across the winding to change from a first impedance to a second impedance in response to operating conditions in the lamps. This feature avoids high operating voltages that can occur across the cross-coupled inductors when one of the fluorescent lamps is inoperable and/or removed from the lamp sockets.

### BACKGROUND

1. Technical Field

The subject matter of the present disclosure relates to lamps and lighting devices and, more particularly, to exemplary circuitry that manages current and voltage levels in lighting devices.

2. Description of Related Art

Lighting devices that generate light with fluorescent lamps have been available for over one hundred (100) years. In some implementations, the lighting device couples with a dimming circuit in a home and/or office building with dimmer switches that control illumination of the fluorescent lamps. Examples of these dimming circuits allow an end user to adjust the intensity of light from the fluorescent lights.

Ballast circuits in the lighting device, which convert low-frequency supply voltage into a high-frequency AC voltage, may cause fluorescent lamps in the same lighting device to illuminate at different brightness levels when used with the dimmer circuit. The ballast circuit may, for example, include lamp sockets that receive and operate the fluorescent lamps in parallel. However, this configuration can induce current-sharing problems that generate current of different levels at the lamp sockets. The different current levels, in turn, illuminate the fluorescent lamps at different brightness levels. Lowering the dimmer switches can make the current-sharing problems become more readily apparent. In one example, the dimmer switch will reach a position at which the current at the lamp sockets will illuminate only one of the fluorescent lamps.

To address the current-sharing problems, ballast circuits may include cross-coupled inductors in series with the lamp sockets. This arrangement balances current levels across the lamp sockets and, thus, can prevent the differences in illumination during dimming. However, designs that utilize cross-coupled inductors can generate voltages at high levels when one of the fluorescent lamps reaches the end of its life, is removed from the lamp socket, or fails to operate as designed or intended. The resulting voltage levels can cause electric shock and/or can damage components of the ballast circuit. One solution to prevent these unsafe conditions is to simply disable the entire lighting device, thereby preventing the lighting device from generating light.

Accordingly, there is a need for lighting devices that operate fluorescent lamps in parallel but that can maintain illumination across the fluorescent lamps during dimming and continue to operate during one or more of the failure conditions noted herein.

### BRIEF DESCRIPTION OF THE INVENTION

The present disclosure describes, in one embodiment, a lighting device that comprises a ballast circuit with a first lamp socket and a second lamp socket, a cross-coupled inductor having a first winding in series with the first lamp socket and a second winding in series with the second lamp socket. The lighting device also comprises a protection circuit coupled with the ballast circuit. The protection circuit comprises a disable winding magnetically coupled with the first winding and the second winding and a control circuit coupled with the disable winding. The control circuit comprises a switching component that is configured to cause impedance across the disable winding to change from a first impedance to a second impedance that is less than the first impedance.

The present disclosure also describes, in one embodiment, a lighting device with a first lamp and a second lamp. The lighting device comprises a core comprising magnetic material and a plurality of windings wound about the core. The plurality of windings comprising a first winding, a second winding, and a third winding. The lighting device also comprises a control circuit coupled with the plurality of windings. The control circuit includes a switching component that is configured to cause impedance one of the first winding, the second winding, and the third winding to change from a first impedance to a second impedance that is less than the first impedance.

The present disclosure further describes, in one embodiment, a ballast circuit for a lighting device comprising a pair of fluorescent lamps. The ballast circuit comprises a first winding, a second winding magnetically coupled with the first winding, and a pair of lamp sockets coupled in series with one of the first winding and the second winding. The pair of lamp sockets are configured to receive the pair of fluorescent lamps. The ballast circuit also includes a disable component magnetically coupled with the first winding and the second winding, the disable component comprising a third winding and a switching component that is configured to cause impedance across the third winding to change from a first impedance to a second impedance that is less than the first impedance.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 depicts a schematic diagram of an exemplary embodiment of a lighting device with a current-balancing component and a disable component to allow operation of a single lamp in a true-parallel lamp configuration;

FIG. 2 depicts a schematic wiring diagram for a topology of an exemplary embodiment of a lighting device in which the protection circuit can measure voltage across a winding;

FIG. 3 depicts a schematic wiring diagram for a topology an exemplary embodiment of a lighting device in which the control circuit can measure signal parameters at a lamp socket;

FIG. 4 depicts a schematic wiring diagram of an exemplary embodiment of a lighting device that includes one configuration of windings that magnetically couples on a core;

FIG. 5 depicts a schematic wiring diagram of a topology of an exemplary embodiment of the lighting device that includes components of a ballast circuit and a protection circuit of the present disclosure; and

FIG. 6 depicts a schematic wiring diagram for the topology of an exemplary embodiment of a lighting device that includes a protection circuit with a center-tapped winding.

Where applicable, like reference characters designate identical or corresponding components and units throughout the several views, which are not to scale unless otherwise indicated.

### DETAILED DESCRIPTION OF THE INVENTION

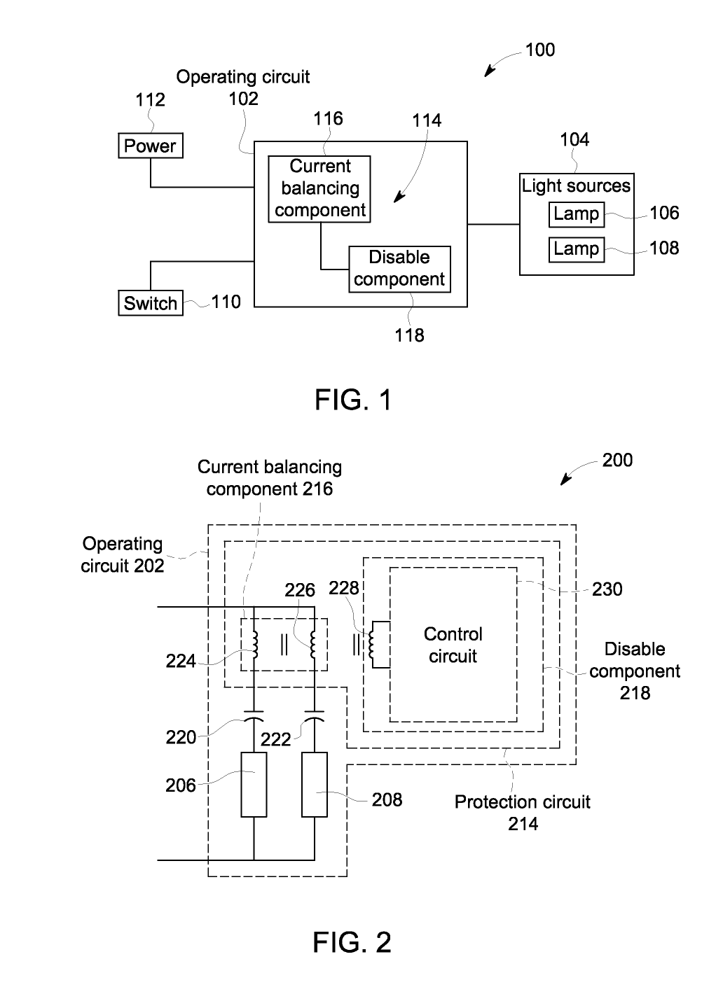

FIG. 1 illustrates a schematic diagram of a lighting device 100 that incorporates features to protect against rapid voltage increases indicative of failure in the lighting device. The lighting device 100 includes an operating circuit 102 that couples with a light source 104, which in this example has a first lamp socket 106 and a second lamp socket 108 that can receive and secure a fluorescent lamp therein. In one example, the operating circuit 102 couples with an external switch 110 and receives an input from a power source 112 (e.g., an alternating current (AC) source). The external switch 110 can have a user interface (e.g., a slider control and/or rocker control). Actuation of the user interface can vary operation of the operating circuit 102, which can change parameters (e.g., current, voltage, etc.) of an output of the operating circuit 102 generates to energize the light source 104.

At a relatively high level, the operating circuit 102 includes a protection circuit 114 with a current balancing component 116 and a disable component 118. The components of the protection circuit 114 permit operation of the lighting device 100 with lamp sockets 106, 108 and cross-coupled windings of inductors in series with the lamp sockets 106, 108. This configuration of the lamp sockets 106, 108 is favorable over other configurations for use in applications that require forced-current sharing. Exemplary applications include dimming, wherein actuation of the external switch 110 modifies operation of the operating circuit 102 to increase and/or decrease the voltage (e.g., from 0 V to 10 V) of the output from the operating circuit 102 to the lamp sockets 106, 108. In one example, the voltage reflects the position of the actuator on the external switch 110 to modifies the illumination characteristics (e.g., brightness) of the fluorescent lamps in the lamp sockets 106, 108.

The current balancing component 116 couples with the lamp sockets 106, 108 in series and/or to form a series circuit. This feature balances the current levels of the output that energizes the lamp sockets 106, 108. Examples of the current balancing component 116 maintain illumination of fluorescent lamps in the lamp sockets 106, 108 at consistent levels during dimming. This feature avoids perceptible differences in the illumination levels that can occur in conventional lighting devices that combine lamp sockets (e.g., lamp sockets 106, 108) without cross-coupled windings of inductors in series with the lamp sockets.

The disable component 118 couples with the current balancing component 116. This component prevents rapid rise in voltage that can occur in response to reductions in current draw across one of the lamp sockets 106, 108. The change in current draw can occur, for example, when fluorescent lamps are removed from one of the lamp sockets 106, 108 and/or fails, e.g., reaches end-of-life during operation of the lighting device 100. These operating conditions can lead to unsafe voltage levels that can damage the operating circuit 102 and/or cause injuries. Operation of the disable component 118, however, regulates the voltage in the operating circuit 102 at safe levels, e.g., by maintaining disabling the action of the cross-coupled windings in series with the lamp sockets 106, 108.

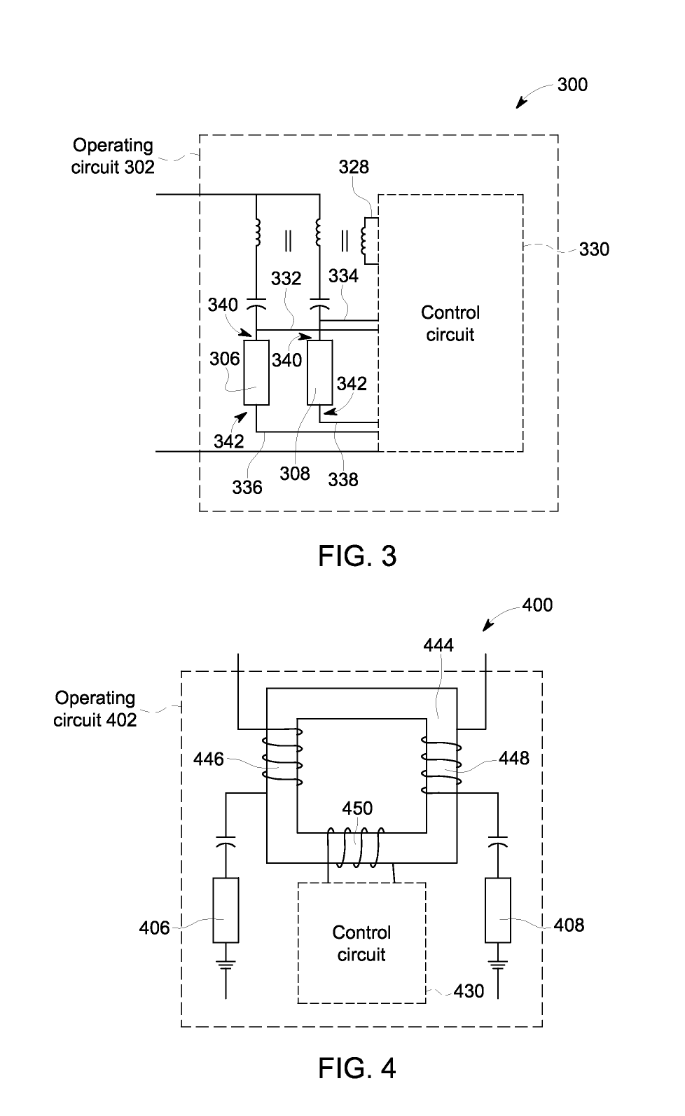

FIGS. 2 and 3 depict schematic diagrams for topology of an exemplary embodiment of a lamp 200 (FIG. 2) and a lamp 300 (FIG. 3) that can maintain voltage at safe, operating levels. In FIG. 2, the operating circuit 202 includes a first capacitor 220 and a second capacitor 222. Examples of capacitors 220, 222 include direct current DC blocking capacitors, which couple in series with, respectively, the first lamp socket 206 and the second lamp socket 208. The current balancing component 216 includes a pair of windings (e.g., a first winding 224 and a second winding 226). In one example, the windings 224, 226 couple in series with the capacitors 220, 222. The disable component 218 includes a third winding 228 and a control circuit 230. As set forth more below, the windings 224, 226, 228 can generate magnetic fields in response to electrical stimulation and, further, are coupled so that a change in current in one of the windings 224, 226, 228 induces voltage in the other of the windings 224, 226, 228.

FIG. 3 illustrates another configuration of the operating circuit 302, which generates the output that energizes fluorescent lamps in the lamp sockets 306, 308. The operating circuit 302 includes one or more leads (e.g., a first lead 332, a second lead 334, a third lead 336, and a forth lead 338). The first lead 332 and the second lead 334 couple with the control circuit 330 and with a first end 340 of the lamp sockets 306, 308. The third lead 336 and the fourth lead 338 couple with the control circuit 330 with a second end 342 of the lamp sockets 306, 308.

Examples of the control circuits 230, 330 can initiate a virtual short condition across third windings 228, 328 in response to operating characteristics of the operating circuits 202, 302. The virtual short defines a change in impedance across the disable winding, e.g., from a first impedance to a second impedance that is less than the first impedance. The change in impedance can fall in a range of 1 Mohm (e.g., the first impedance) to 1 ohm (e.g., the second impedance). In one example, in the configuration of FIG. 2, the control circuit 230 can monitor the voltage level across the third winding 228. The configuration of FIG. 3 illustrates one example where the control circuit 330 can monitor voltage and/or current (and/or other characteristics (e.g., impedance)) across the lamp sockets 306, 308.

As set forth in more detail below, control circuits 230, 330 can initiate the virtual short when one or more of the operating characteristics fails to satisfy a threshold criteria, e.g., the operating characteristics meets and/or exceeds a threshold voltage level, a threshold current level, and the like. This virtual short condition allows disable windings 228, 328 to conduct the input current at levels that are equal to normal operating current, thereby avoiding the dangerous and/or damaging voltage conditions on operating circuits 202, 302. This features allows operating circuits 102, 202, 302 (e.g., a ballast circuits) to continue to operate when one of the lamp sockets 206, 208 is no longer operational and/or the fluorescent lamp is removed from the lamp socket 206, 208.

FIG. 4 illustrates a schematic diagram of an exemplary embodiment of a lighting device 400 of the present invention. The operating circuit 402 includes a core 444 and a plurality of windings (e.g., a first winding 446, a second winding 448, and a third winding 450). Windings 446, 448, 450 have turns that wrap about the core 444. Examples of the core 444 comprise magnetic material (e.g., ferrites) that can generate a magnetic field in response to the input power signal that energizes windings 446, 448, 450. In one embodiment, windings 446, 448, 450 can have the same number of turns, which can be selected to tune the strength of the magnetic field that occurs in the core 444, as discussed below.

During operation, i.e., in response to the input power signal, the first winding 446 generates a first magnetic field that is proportional to the magnitude of the current of the input power signal from a power source (e.g., power source 112) and flows in a first direction around the core 444. The second winding 448 generates a second magnetic field that is proportional to the magnitude of the current of the input power signal and flows in a second direction around the core 444. Fluctuations in the magnitude of the input current will cause a voltage across the first winding 446 and the second winding 448. In one embodiment, the impedance of the first lamp socket 406 and the second lamp socket 408 are different, which causes a small difference in the current at the lamp sockets 406, 408. The difference in the current induces different field strengths for the first magnetic field and the second magnetic field. The difference in the magnetic field strength, in turn, induces a voltage across the first winding 446 and the second winding 448 that balances the current in the lamp sockets 406, 408, i.e., increases the current in the winding and the lamp socket with the lower current and decreases current in the winding with the higher current value. This mechanism effectively balances the current level that flows in both the lamp sockets 406, 408, thus avoiding perceptible differences in the illumination levels of the lamp sockets 406, 408 during dimming.

The operating circuit 402 can recognize failure conditions, e.g., a failure in one of the lamp sockets 406, 408 and/or removing the fluorescent lamp from one of the lamp sockets 406, 408. These failure conditions occur when dissimilar current flows through the lamp sockets 406, 408. The failure condition results in a change in one of the magnetic fields of windings 446, 448 (e.g., the first magnetic field and/or the second magnetic field), which causes a net magnetic field to develop. The net magnetic field will cause the voltage across the third winding 450 to change from a first voltage to a second voltage, which is different from the first voltage. The control circuit 430 can generate the virtual short, which reduces impedance across the third winding 450, in response to the second voltage. The net magnetic field occurring during the failure condition will cause current to flow in the virtual short. The current induces a third magnetic field to flow in a direction around the core 444 that reduces, and likely eliminates, the net magnetic field. This mechanism effectively reduces the voltage level across the first winding 446, the second winding 448, and the third winding 450, thus avoiding the high voltage conditions that can damage the operating circuit 402 and/or render the operating circuit 402 unsafe. Moreover, the operating circuit 402 can continue to operate to supply current to illuminate the remaining fluorescent lamp in the lamp sockets 406, 408.

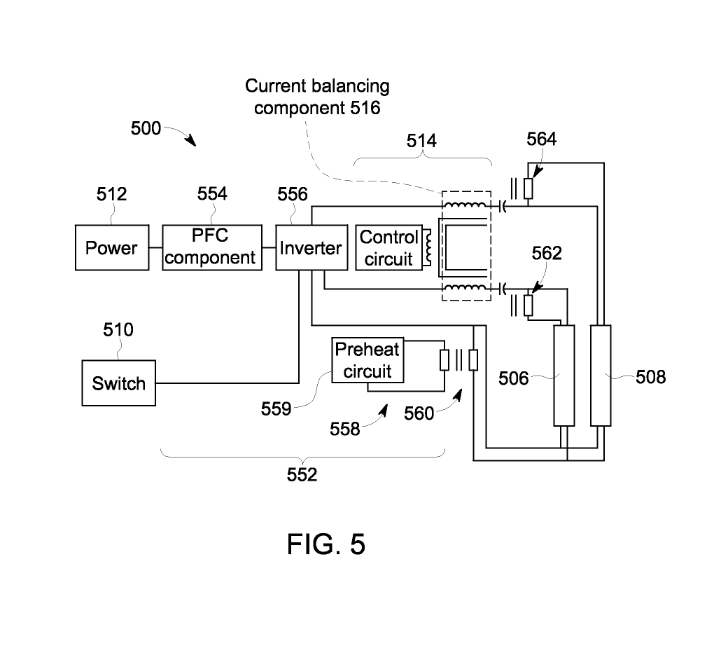

FIG. 5 illustrates a schematic diagram of an exemplary embodiment of a lamp 500 of the present invention. The protection component 514 couples with a ballast circuit 552. The ballast circuit 552 also includes a power factor correction (PFC) component 554, an inverter component 556, and a pre-heat component 558. The pre-heat component 558 includes a pre-heat circuit 559 a pre-heat transformer with a first pre-heat winding 560, a second pre-heat winding 562, and a third pre-heat winding 564.

During operation, the PFC component 554 can counteract distortion in the input power signal from the power source 512. The PFC component 554 can, for example, actively or passively raise the ratio of real power to apparent power flowing from the power source 512. Examples of the inverter component 556 converts the input power signal, e.g., from direct current (DC) to alternating current (AC), which is received by the current balancing component 516. Operation of the switch 510 causes the inverter 556 to dim the lamp sockets 506, 508. In one example, the switch 510 can provide voltage in a range of 0 V to 10 V.

In one embodiment, the preheat component 558 generates a preheat voltage to increase the temperature of the filaments inside of the first lamp socket 506 and the second lamp socket 508. After the filaments reach a desired temperature, the preheat component 558 eliminates the preheat voltage. The inverter component 556 then provides high voltage to the first lamp socket 506 and the second lamp socket 508 to initiate discharge in the fluorescent lamp, which causes the fluorescent lamp to generate light. In one example, the ballast circuit 552 can change the frequency of the output from a first frequency that preheats the filaments in the first lamp socket 506 and the second lamp socket 508 to a second frequency that ignites the first lamp socket 506 and the second lamp socket 510. By including the preheat component 558 and the preheat windings 560, 562, 564, the ballast circuit 552 can increase the temperature of the filaments in fluorescent lamps installed in the first lamp socket 506 and the second lamp socket 508 prior to ignition. This feature can reduce the voltage necessary to ignite or to illuminate the fluorescent lamps, thus minimizing deterioration and other degradation of the filaments that can shorten the lifespan of the fluorescent lamps.

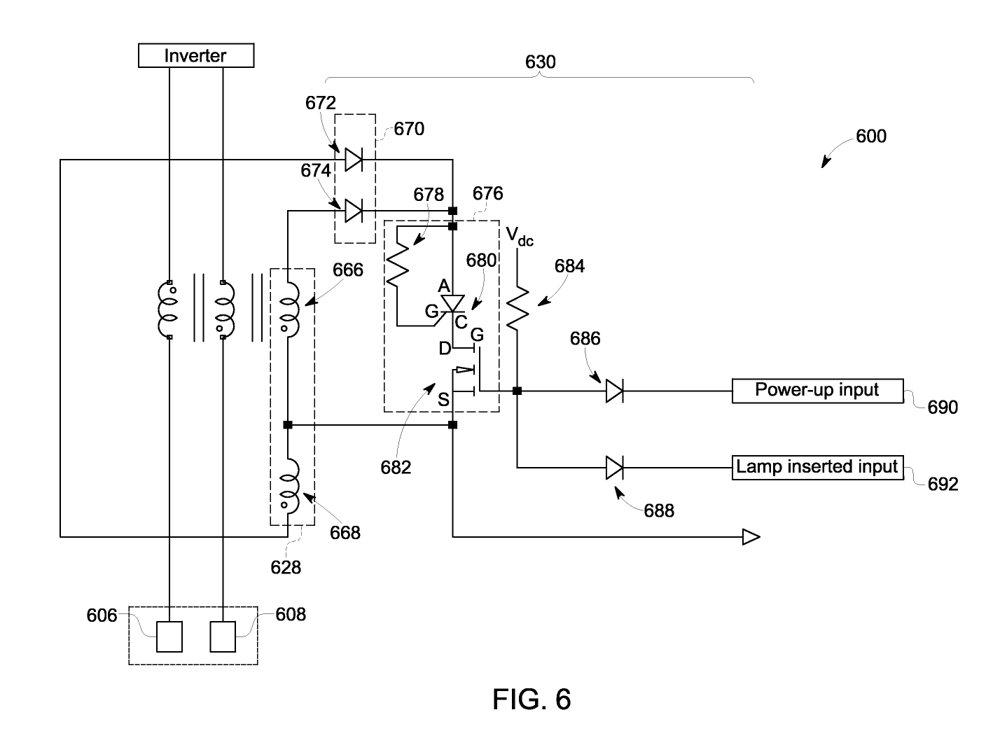

FIG. 6 depicts a wiring schematic that shows topology for an exemplary embodiment of a lighting device 600. This topology includes various components (e.g., resistors, capacitors, switches, diodes, etc.) that are useful and can embody the design of the various circuitry found in the lighting device 500. This disclosure also contemplates other configurations of components that would form topologies other than that shown in the figures.

Moving from left to right in FIG. 6, the disable winding 628 has a center-tapped configuration that includes a first disable winding 666 and a second disable winding 668. The disable winding 628 couples with a rectifier 670 that has a first rectifier diode 672 and a second rectifier diode 674. The control circuit 630 has a switching component 676 that regulates the virtual short across the disable winding 628. The switching component 676 includes a switching resistor 678 coupled in series with a thyristor 680 and a switch 682 coupled in series with the thyristor 680. Examples of the thyristor 680 include silicon controlled rectifier (SCR) elements, which can have an anode (A), a cathode (C), and a gate (G). The switch 682 can comprise a field effect transistor (FET) element having a drain (D), a gate (G), and a voltage source (S). In one embodiment, the control circuit 630 can include a source resistor 684 and a set of input diodes (e.g., a first input diode 686 and a second input diode 688) that couple with one or more input circuits (e.g., a power-up detection circuit 690 and a lamp inserted input 692).

During operation, the rectifier 670 rectifies the waveform (e.g., an alternating current (AC) waveform) of the input power signal from the disable winding 628. The rectified signal is applied to the switching component 676. In one embodiment, the switch 682 has a first position that disables the virtual short across the disable winding 628 and a second position that enables the virtual short across the disable winding 628. If the switch 682 is in the second position, or in one example “closed,” the voltage of the disable winding 628 impresses across the anode (A) to the cathode (C) of the thyristor 680. The voltage of the disable winding 628 will also appear on the switching resistor 678 and across the gate (G) to the cathode (C) of the thyristor 680. In one example, when the voltage across the gate (G) to the cathode (C) of the thyristor 680 exceeds a threshold voltage value, the thyristor 680 transitions from a first impedance state to a second impedance state across the anode (A) to the cathode (C), which is different from the first impedance state. Examples of the thyristor 680 will remain in the second impedance state until the current across the anode (A) to cathode (C) reverses and/or ceases (e.g., the current level drops to zero and/or below a threshold current value). In one example, the state of the thyristor 680 changes from the second impedance state to the first impedance state in response to the position of the switch 682, e.g., the switch 682 changes from the second position to the first position or is “open.”

In one embodiment, the position of the switch 682 changes from the second position to the first position in response to an input. This input can prevent and/or prohibit the virtual short across the disable winding 628, e.g., by causing the switch 682 to open. In one example, the input has a voltage (e.g., approximately 0 V) that causes the switch 682 to open. In another example, the input arises from one or more of the inputs from one or more of the power-up detection circuit 690 and the lamp inserted input 692, which indicates when the fluorescent lamp is inserted into the lamp sockets 606, 608 of the lighting device.

As set forth above, this disclosure describes embodiments of ballast circuitry that permits lighting devices to illuminate a pair of fluorescent lamps with cross-coupled inductors in series with the fluorescent lamps at substantially uniform levels. These embodiments also can maintain operation and illumination of one fluorescent lamp during failure conditions, e.g., when the other fluorescent lamp fails, reaches end-of-life, or is missing from the lighting device. To this end, the proposed circuitry maintains voltage in the lighting device at safe levels to avoid risks of shock that can arise during one of these failure conditions. In one example, the circuitry utilizes the windings that can balance the amount of current in each of the fluorescent lamps, thus, illuminating both lamps at substantially the same level of brightness.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose embodiments of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A lighting device, comprising:
a ballast circuit comprising a first lamp socket and a second lamp socket, a cross-coupled inductor having a first winding in series with the first lamp socket and a second winding in series with the second lamp socket; and
a protection circuit coupled with the ballast circuit, the protection circuit comprising a disable winding magnetically coupled with the first winding and the second winding and a control circuit coupled with the disable winding, the control circuit comprising a switching component that is configured to cause impedance across the disable winding to change from a first impedance to a second impedance that is less than the first impedance.

2. The lighting device of claim 1, further comprising a first capacitor and a second capacitor in series with, respectively, the first lamp socket and the third lamp socket.

3. The lighting device of claim 1, wherein the control circuit is configured to measure voltage across the disable winding.

4. The lighting device of claim 1, wherein the control circuit couples with at least one of a first end and a second end of the first lamp socket and the second lamp socket.

5. The lighting device of claim 4, wherein the control circuit couples with the first end and the second of the first lamp socket and the second lamp socket.

6. The lighting device of claim 1, wherein the switching component comprises a thyristor and a switch coupled in series with the thyristor.

7. The lighting device of claim 6, wherein the thyristor comprises a silicon controlled rectifier (SCR) element.

8. The lighting device of claim 6, wherein the switching component comprises a resistor coupled in series with the switch.

9. The lighting device of claim 1, wherein the first winding, the second winding, and the third winding are wound about a core.

10. A lighting device with a first lamp and a second lamp, said lighting device comprising:
a core comprising magnetic material;
a plurality of windings wound about the core, the plurality of windings comprising a first winding, a second winding, and a third winding; and
a control circuit coupled with the plurality of windings, the control circuit comprising a switching component that is configured to cause impedance on one of the first winding, the second winding, and the third winding to change from a first impedance to a second impedance that is less than the first impedance.

11. The lighting device of claim 10, wherein the first winding and the second winding are wound in opposite directions.

12. The lighting device of claim 10, wherein the third winding is wound in the same direction as one of the first winding and the second winding.

13. The lighting device of claim 10, wherein switching component comprises a silicon controlled rectifier (SCR) element and a switch coupled in series with the SCR element.

14. A ballast circuit for a lighting device comprising a pair of fluorescent lamps, said ballast circuit comprising:
a first winding;
a second winding magnetically coupled with the first winding;
a pair of lamp sockets coupled in series with the first winding and the second winding, wherein the pair of lamp sockets are configured to receive the pair of fluorescent lamps; and
a disable component magnetically coupled with the first winding and the second winding, the disable component comprising a third winding and a switching component that is configured to cause impedance across the third winding to change from a first impedance to a second impedance that is less than the first impedance.

15. The ballast circuit of claim 14, wherein the first winding and the second winding magnetically couple with the third winding.

16. The ballast circuit of claim 14, further comprising a core, wherein the first winding, the second winding, and the third winding comprise turns disposed about the core.

17. The ballast circuit of claim 14, further comprising a rectifier coupled in series with the switching component.

18. The ballast circuit of claim 14, wherein the switching component comprises a switch having a first position and a second position, and wherein one of the first position and the second position couples the switching component with the first lamp socket and the second lamp socket.

19. The ballast circuit of claim 18, wherein the switch comprises a field effect transistor (FET) element.

20. The ballast circuit of claim 14, wherein the control circuit is configured to measure voltage across the disable winding.
